(19) United States
(12) Patent Application Publication
(10) Pub. No.: US 2005/0254506 A1
(43) Pub. Date: Nov. 17, 2005

(54) Apparatus and method for transporting data over a ring structure

(76) Inventor: Derek Edward Davout Gladding, San Francisco, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/842,779

(22) Filed: May 11, 2004

(51) Int. Cl. H04L 12/56

(52) U.S. Cl. 370/404

(57) ABSTRACT

Systems and methods are presented in which nodes are interconnected using both a wide ring and a narrow ring. The wide ring has a data capacity that is greater than the data capacity of the narrow ring. Each node transmits and receives data over both the wide ring and the narrow ring, depending on the size of the data packets. The narrow ring is used to transport data having a relatively small data capacity, while the wide ring is used to transport data having a packet size that exceeds the data capacity of the narrow ring. In some embodiments, a “pull” mechanism is employed in order to avoid deadlocks in data transport.

### FIELD OF THE INVENTION

The present disclosure relates generally to computer architecture and, more particularly, to data transport using ring structures.

### BACKGROUND

Often, in computationally intensive environments, multiple processing units are employed to execute various tasks. In those environments, the multiple processing units are interconnected so that data can be freely exchanged between the individual processing units. Many different architectures can be used to interconnect the individual processing units. Among the common architectures are buses, trees, crossbars, switching networks (for example, omega networks), and rings.

When designing such architectures, multiple factors are often considered, such as bandwidth, silicon area, and ease of implementation. Given these factors, ring structures (or simply “rings”) provide a better balance of bandwidth, silicon area, and ease of implementation than the other structures. For example, buses provide lower bandwidth than rings, and cause floor-planning problems. While tree structures and crossbars provide higher bandwidths, these architectures are often complex to control and consume a large amount of silicon area. Additionally, crossbars are not easily scalable. Switching networks are more complex to control than rings, and the floor-planning for switching networks is more difficult than for rings.

While many ring structures are known in the art, there is nevertheless an ongoing effort to improve their efficiency.

### SUMMARY

The present disclosure provides systems and methods for transporting data over a ring structure.

Briefly described, one embodiment of the system, among others, comprises a pair of wide rings, a pair of narrow rings, and nodes that are electrically coupled to the wide and narrow rings. One wide ring transports data in a clockwise direction, while the other wide ring transports data in a counterclockwise direction. Similarly, one narrow ring transports data in a clockwise direction, while the other narrow ring transports data in a counterclockwise direction. The wide ring has a data capacity that is greater than the data capacity of the narrow ring. Each node transmits and receives data over either the wide ring or the narrow ring, depending on the size of the data packet.

One embodiment of the method, among others, comprises the steps of determining whether there is inbound data from an adjacent node, receiving the inbound data when there is inbound data from the adjacent node, and determining whether the received data has reached its destination.

Another embodiment of the method, among others, comprises the steps of electrically coupling a first node and a second node over a wide ring, and electrically coupling the first node and the second node over a narrow ring. The wide ring has a data capacity that is greater than the data capacity of the narrow ring.

Other systems, devices, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing an embodiment of a ring architecture having a wide ring and a narrow ring.

FIG. 2 is a block diagram showing, in greater detail, two nodes on the ring architecture of FIG. 1.

FIG. 3 is a block diagram showing, in greater detail, processing units within a node of FIG. 2.

FIG. 4 shows a conceptual separation of the logical functions associated with the inbound-data-determination logic of FIG. 3.

FIG. 5 shows a conceptual separation of the logical functions associated with the output logic of FIG. 3.

FIG. 6 is a flowchart showing an embodiment of a method for transporting data using a ring architecture.

FIG. 7 is a flowchart showing an embodiment of a process that is carried out at a node on a ring.

### DETAILED DESCRIPTION OF THE EMBODIMENTS

Reference is now made in detail to the description of the embodiments as illustrated in the drawings. While several embodiments are described in connection with these drawings, there is no intent to limit the invention to the embodiment or embodiments disclosed herein. On the contrary, the intent is to cover all alternatives, modifications, and equivalents.

While ring architectures provide a good balance between bandwidth, silicon area, and ease of implementation, there is a continuing effort to increase the efficiency of ring architectures. For example, the ring architecture is often constructed with a ring having a fixed data capacity. Typically, the fixed data capacity provides the maximum limit for the packet size that can be transported over the ring. Thus, the data capacity of the ring is often chosen to reflect the size of the largest data packet that is transported. Unfortunately, if smaller data packets, which occupy less than the full capacity of the ring, are transported over the ring, then much of the capacity of the ring is unused, thereby resulting in inefficiency.

Several embodiments of the invention, which are disclosed herein, provide systems and methods in which a ring architecture includes both a wide ring and a narrow ring. The narrow ring permits the transport of relatively small data packets, while the wide ring permits the transport of larger data packets. By having such a configuration, smaller data packets can be transported across the ring without much unused capacity. Additionally, larger packets, which exceed the capacity of the narrow rings, can be transported across the wide rings, since the wide rings have sufficient capacity to carry the larger data packets.

The combination of a wide and narrow ring provides greater bandwidths than conventional bus-based schemes. Also, such a ring architecture is less affected by physical limitations and, also, more area-efficient than alternative schemes. Additionally, the ring architecture reduces the physical distance that a signal travels between nodes, thereby permitting a corresponding increase in operational clock rates. Also, unlike bus structures in which only one operational unit can transmit data, the ring architecture permits concurrent communications by multiple operational units.

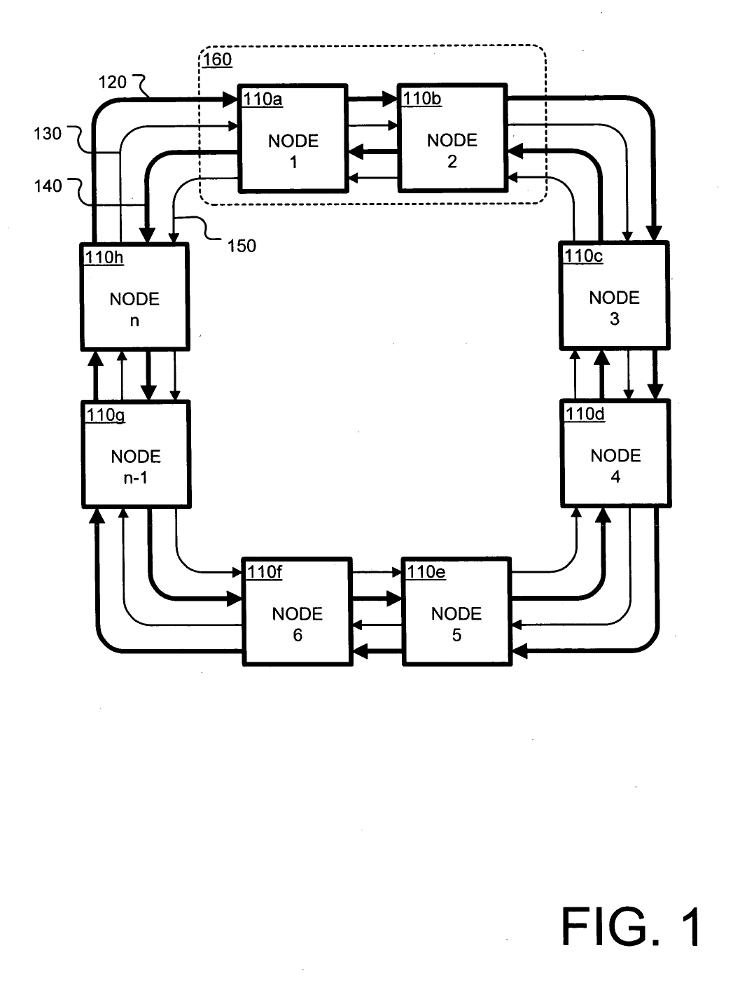

FIG. 1 is a block diagram showing an embodiment of a ring architecture having wide rings 120, 140 and narrow rings 130, 150. As shown in FIG. 1, multiple nodes 110a. . . 110h (or simply 110) are electrically coupled to each of the rings 120, 130, 140, 150, thereby providing a circular and serial communications pathway that interconnects the nodes 110. In the embodiment of FIG. 1, the ring architecture comprises a clockwise (CW) wide ring 120, a CW narrow ring 130, a counterclockwise (CCW) wide ring 140, and a CCW narrow ring 150.

The CW rings 120, 130 are configured to transport data in a clockwise direction, while the CCW rings 140, 150 are configured to transport data in a counterclockwise direction. In this regard each node 110 is capable of bi-directional communications using the ring architecture. The wide rings 120, 140 have a greater data capacity than the narrow rings 130, 150. For example, in one embodiment, among others, the wide rings 120, 140 may be configured to accommodate 320-bit packets of data, while the narrow rings 130, 150 may be configured to accommodate 40-bit packets of data. Thus, any data having a packet size that does not exceed 40 bits is transported using the narrow rings 130, 150, while any data having a packet size that exceeds 40 bits is transported using the wide rings 120, 140.

While 320-bit and 40-bit packet sizes are used to illustrate the difference in data capacity between wide rings 120, 140 and narrow rings 130, 150, it should be appreciated that the specific packet sizes can be altered as a matter of design choice, so long as the wide rings 120, 140 have a greater data capacity than the narrow rings 130, 150. For simplicity, the phrases “large packets” and “small packets” are used to describe the sizes of the data packets that are associated with the wide rings 120, 140 and the narrow rings 130, 150, respectively. Also, while four rings 120, 130, 140, 150 are shown to illustrate bi-directional data-transport capabilities, it should be appreciated that, in a broad sense, a single wide ring 120 and a single narrow ring 130 can be used to transport data between all of the nodes 110. Furthermore, it should be appreciated that additional rings may be added in order to provide greater flexibility in data transport.

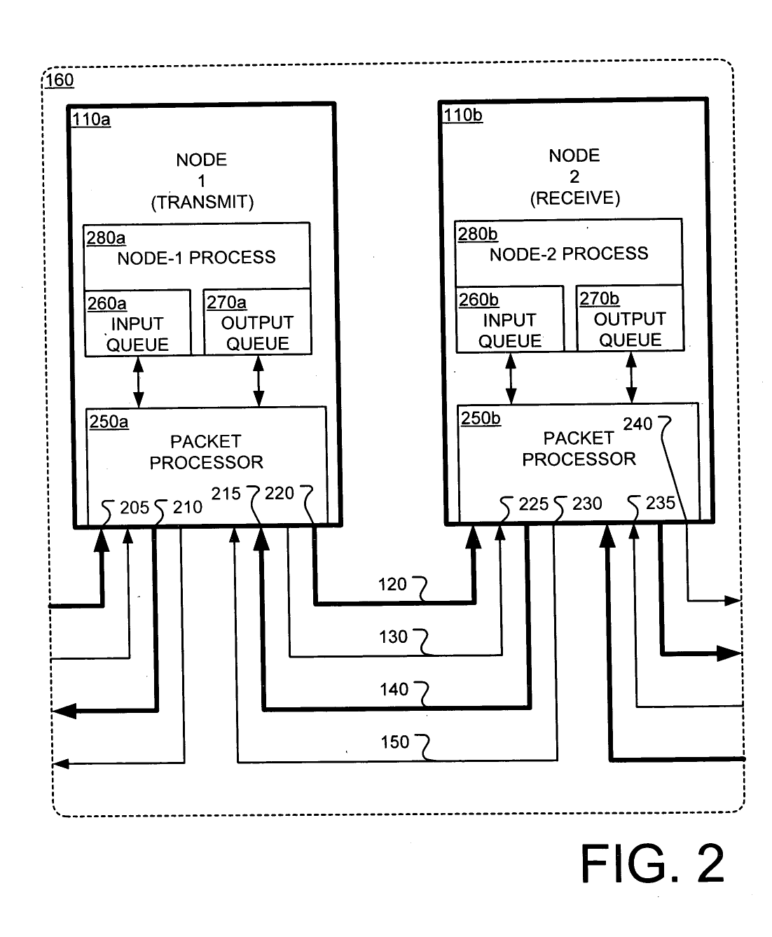

FIG. 2 is a block diagram showing, in greater detail, two nodes 160 on the ring architecture of FIG. 1. In an example embodiment, the nodes 110 are substantially identical and perform both data transmitting as well as data receiving functions. However, in an effort to more clearly illustrate these separate functions, the transmitting and receiving functions are separated in the illustration of FIG. 2. Thus, as shown in FIG. 2, the first node 110a is arbitrarily designated as a transmitting node 110a, while the second node 110b is arbitrarily designated as the receiving node 110b.

The transmitting node 110a and the receiving node 110b (collectively referred to as 110) of FIG. 2 each include an input queue 260a, 260b (collectively 260), an output queue 270a, 270b (collectively 270), and a packet processor 250a, 250b (collectively 250). The input queues 260 and the output queues 270 are both communicatively coupled to their respective packet processors 250. The packet processors 250 are configured to handle the receiving and transmitting of data between the nodes 110.

Each node 110 also includes a process 280a, 280b (collectively 280), which may execute a dedicated math co-processing function, a graphics function, or a variety of other functions that are associated with computational units. Since those processes should be apparent to those of skill in the art, further discussion of such processes is omitted here.

The input queue 260 and the output queue 270 are interposed between the packet processor 250 and the node process 280. In that regard, the input queue 260 receives data from the packet processor 250 and provides the received data to the process 280. Conversely, the output queue 270 receives processed data from the process 280 and provides the processed data to the packet processor 250 for output to one of the rings 120, 130, 140, 150.

Each node 110 has inputs/outputs (I/O) associated with each of the rings 120, 130, 140, 150. For example, each node 110 has a clockwise (CW) wide input 205 that receives large packets that are transported over the CW wide ring 120. Each node 110 also has a CW wide output 220 that places large packets for transport over the CW wide ring 120. Similarly, each node 110 has a CW narrow input 225, which receives small packets that are transported over the CW narrow ring 130, and a CW narrow output 240, which places small packets for transport over the CW narrow ring 130. In addition to the CW inputs 205, 225 and the CW outputs 220, 240, each node 110 has corresponding counterclockwise (CCW) inputs 215, 235 and CCW outputs 210, 230 that receive data and place data onto their respective wide rings 120, 140 and narrow rings 130, 150.

Given the embodiment of FIG. 2, in which the transmitting node 110a is located in the CCW direction from the receiving node 110b, the CW wide output 220 of the transmitting node 110a is electrically coupled to the CW wide input 205 of the receiving node 110b, thereby permitting CW transport of large packets over the CW wide ring 120. Similarly, for the embodiment of FIG. 2, the CW narrow output 240 of the transmitting node 110a is electrically coupled to the CW narrow input 225 of the receiving node 110b, thereby permitting CW transport of small packets over the CW narrow ring 130. Likewise, the CCW wide output 210 of the receiving node 110b is electrically coupled to the CCW wide input 215 of the transmitting node 110a, thus permitting the transport of large packets over the CCW wide ring 140. Finally, the CCW narrow output 230 of the receiving node 110b is electrically coupled to the CCW narrow input 235 of the transmitting node 110a in order to permit the transport of small packets over the CCW narrow ring 150.

In operation, data cascades from one node (e.g., the transmitting node 110a) to another node (e.g., the receiving node 110b) across the rings 120, 130, 140, 150 until the data reaches its intended destination. As described in greater detail below, the packet processor 250 at each node 110 determines whether or not the data has reached its intended destination.

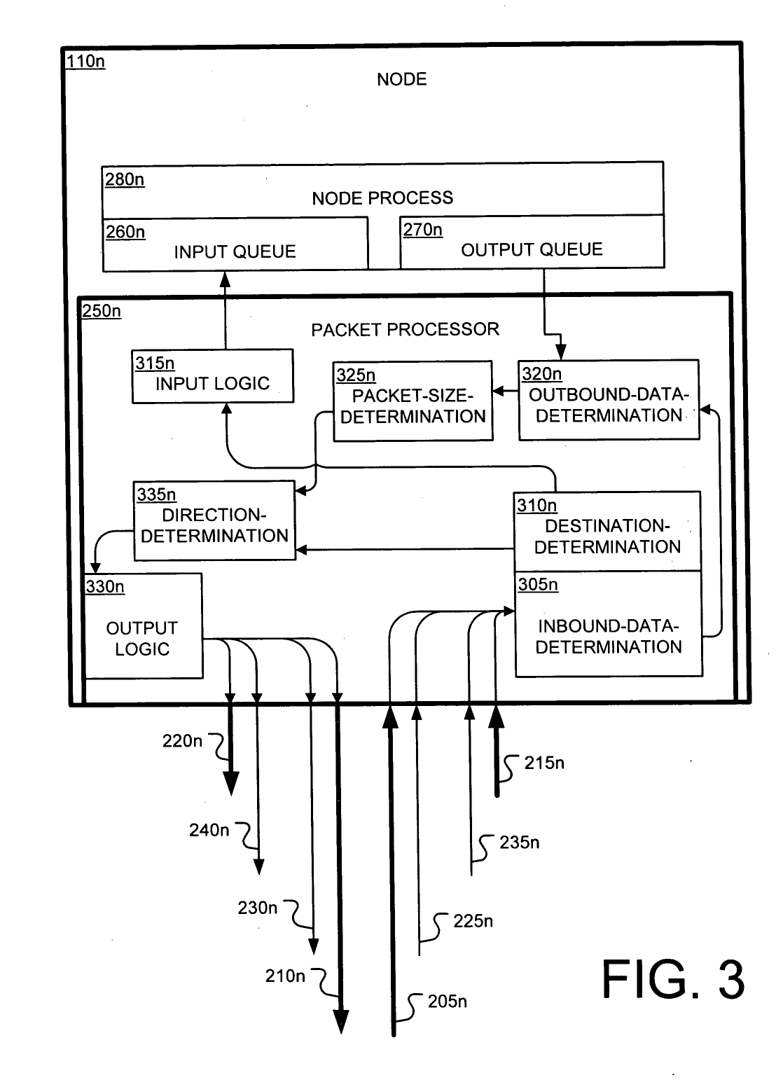

FIG. 3 is a block diagram showing, in greater detail, processing units within a typical node 110n. As shown in FIG. 3, the packet processor 250n comprises inbound-data-determination logic 305n, destination-determination logic 310n, outbound-data-determination logic 320n, packet-size-determination logic 325n, direction-determination logic 335n, input logic 315n, and output logic 330n. Each data packet typically includes a payload and, also, information indicative of the destination. In some embodiments, the information indicative of the destination can be part of the data payload.

The inbound-data-determination logic 305n of the node 110n is electrically coupled to the inputs 205n, 215n, 225n, 235n. Since these inputs 205n, 215n, 225n, 235n are electrically coupled to their corresponding outputs 210n, 220n, 230n, 240n at adjacent nodes, the inbound-data-determination logic 305n determines whether there is any inbound data from the outputs 210n, 220n, 230n, 240n of the adjacent nodes. Should inbound data be available at those outputs 210n, 220n, 230n, 240n, the inbound-data-determination logic 305n receives that inbound data. Should there be no inbound data available from an adjacent node, then the inbound-data-determination logic 305n indicates the absence of inbound data to the outbound-data-determination logic 320n.

In the event that inbound data is received from an adjacent node, the destination-determination logic 310n determines whether or not the node 110n, which received the inbound data, is the destination for the inbound data. In some embodiments, the destination is determined from the information that is conveyed as part of the data. For example, the data may include a data-type field that specifies the destination of the data packet.

If the destination-determination logic 310n determines that the node 110n is not the destination for the inbound data, then the destination-determination logic 310n relays the data to the direction-determination logic 335n, which determines whether the inbound data was traveling in the CW direction or the CCW direction. Upon determining the direction of data transport, the direction-determination logic 335n provides the data to the output logic 330n for output to the appropriate ring 120, 130, 140, 150.

On the other hand, if the destination-determination logic 310n determines that the node 110n is the proper destination for the inbound data, then the destination-determination logic 310n relays the data to the input logic 315n. The input logic 315n is configured to receive data from the destination-determination logic 310n and convey that data to the input queue 260n of the node process 280n.

The outbound-data-determination logic 320n, in response to an absence of inbound data, determines whether or not the node process 280n has provided outbound data to the output queue 270n for output by the node 10n. If the output queue 270n has outbound data, then the outbound-data-determination logic 320n retrieves that outbound data from the output queue 270n and conveys the outbound data to the packet-size-determination logic 325n.

The packet-size-determination logic 325n, upon receiving an outbound data packet, determines whether the outbound packet should be placed on a wide ring 120, 140 or a narrow ring 130, 150. In some embodiments, the appropriate ring 120, 130, 140, 150 is determined by comparing the packet size of the outbound data with the data capacity of the narrow rings 130, 150. If the data capacity of the narrow rings 130, 150 is insufficient for transporting the outbound data, then the outbound data packets are slated for the wide rings 120, 140. Conversely, if the data capacity of the narrow rings 130, 150 is sufficient for transporting the outbound data, then the outbound data packets are slated for the narrow rings 130, 150. Upon determining the packet size of the outbound data, the packet-size-determination logic 325n conveys the outbound packet to the direction-determination logic 335n.

The direction-determination logic 335n determines whether the outbound data packet should be placed on a CW ring 120, 140 or a CCW ring 130, 150. Once the packet size and the direction have been determined by the packet-size-determination logic 325n and the direction-determination logic 335n, respectively, the outbound data is provided to the output logic 330n, which places the outbound data on the appropriate ring 120, 130, 140, 150.

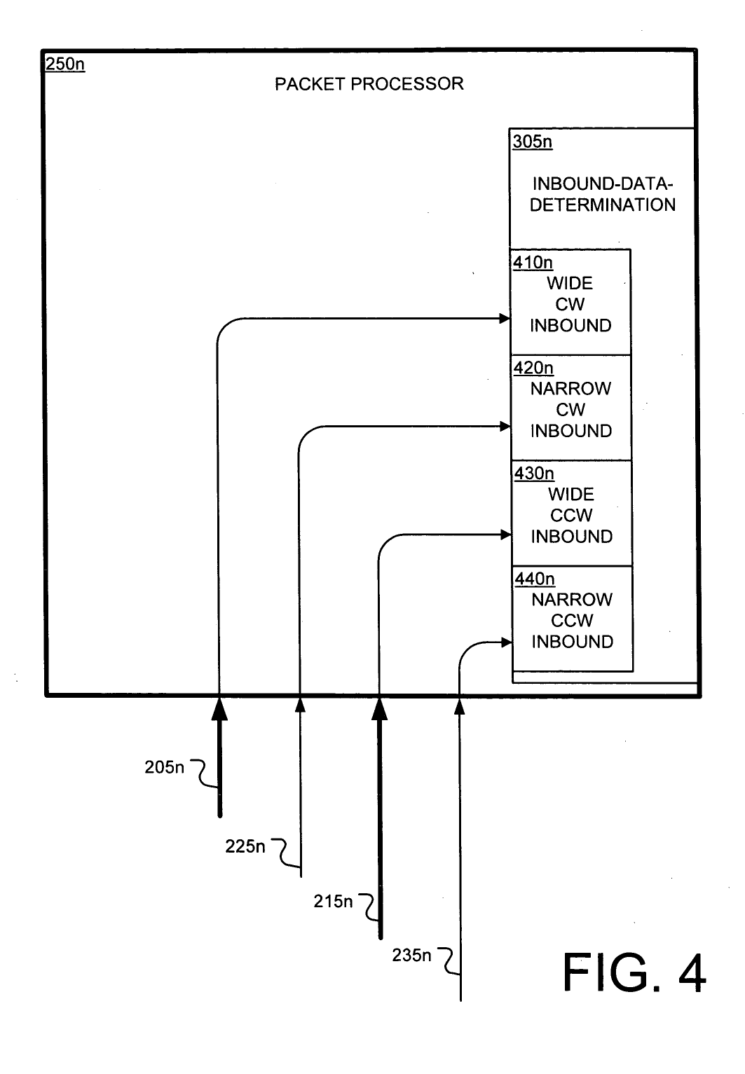

FIG. 4 shows a conceptual separation of the logical functions associated with the inbound-data-determination logic 305n of FIG. 3. As described above, the inbound-data-determination logic 305n determines whether or not there is inbound data from the wide rings 120, 140 as well as from the narrow rings 130, 150, and also determines whether the data is being transported from a CW adjacent node or from a CCW adjacent node. Thus, the inbound-data-determination logic 305n can be seen as four distinct components, each of which determines one of the combinations of wide/narrow and CW/CCW. In that regard, the four distinct components can be conceptually separated as wide-CW-inbound logic 410n, narrow-CW-inbound logic 420n, wide-CCW-inbound logic 430n, and narrow-CCW-inbound logic 440n. The wide-CW-inbound logic 410n is electrically coupled to the CW wide input 205n; the narrow-CW-inbound logic 420n is electrically coupled to the CW narrow input 225n; the wide-CCW-inbound logic 430n is electrically coupled to the CCW wide input 215n; and the narrow-CCW-inbound logic 440n is electrically coupled to the CCW narrow input 235n.

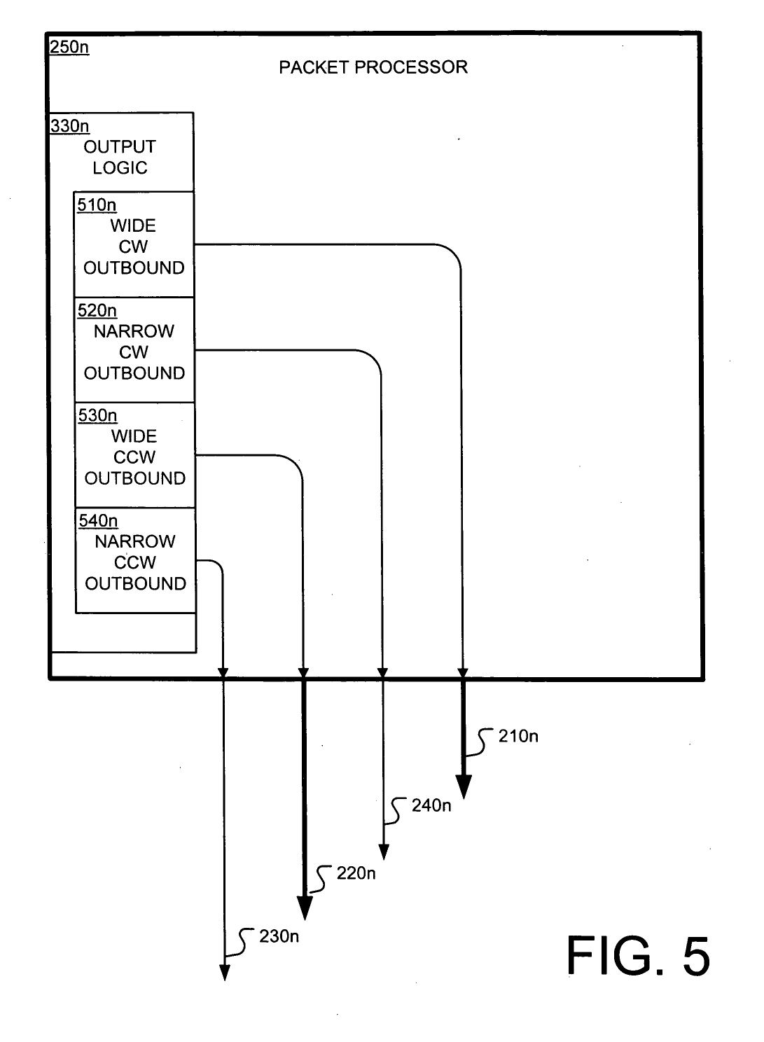

FIG. 5 shows a conceptual separation of the logical functions associated with the output logic 330n of FIG. 3. As described above, the output logic 330n places data onto the appropriate rings. In this regard, the output logic 330n distinguishes between the wide rings 120, 140 and the narrow rings 130, 150, and also distinguishes between data that is being transported CW and data that is being transported CCW. Thus, the output logic 330n can be seen as four distinct components, each of which determines one of the combinations of the wide/narrow and CW/CCW. In that regard, the four distinct components can be conceptually separated as wide-CW-outbound logic 510n, narrow-CW-outbound logic 520n, wide-CCW-outbound logic 530n, and narrow-CCW-outbound logic 540n. The wide-CW-outbound logic 510n is electrically coupled to the CW wide output 210n; the narrow-CW-outbound logic 520n is electrically coupled to the CW narrow output 240n; the wide-CCW-outbound logic 530n is electrically coupled to the CCW wide output 220n; and the narrow-CCW-outbound logic 540n is electrically coupled to the CCW narrow output 230n.

As shown in the embodiments of FIGS. 1 through 5, a ring architecture that is constructed with multiple rings, each having different data capacities, results in greater efficiency by reducing unused data capacity.

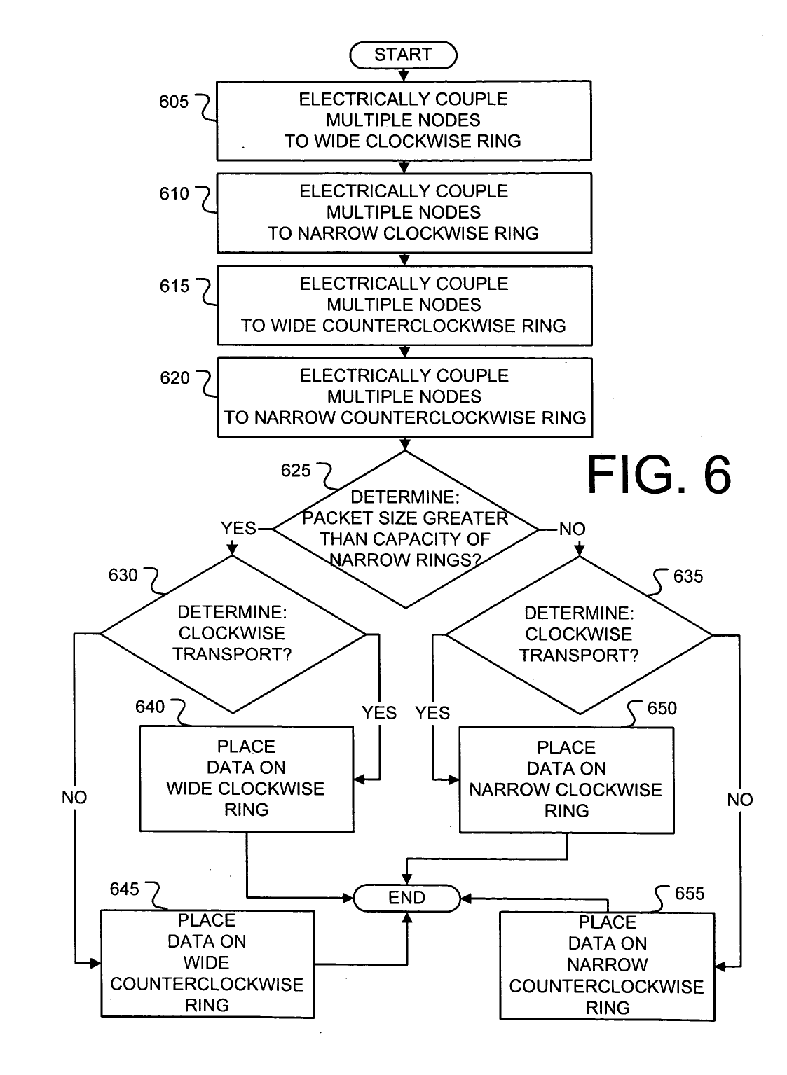

FIG. 6 is a flowchart showing an embodiment of a method for transporting data using a ring architecture. As shown in FIG. 6, one embodiment, among others, comprises the steps of electrically coupling (605) multiple nodes to a wide clockwise (CW) ring. The wide CW ring transports large data packets clockwise from node to node. The embodiment of FIG. 6 further comprises the step of electrically coupling (610) the nodes to a narrow CW ring. The wide CW ring has a data capacity that is greater than the data capacity of the narrow CW ring. In some embodiments, the process further comprises the step of electrically coupling (615) the nodes to a wide counterclockwise (CCW) ring and, also, electrically coupling (620) the nodes to a narrow CCW ring. Similar to the CW rings, the wide CCW ring has a greater data capacity than the data capacity of the narrow CCW ring. In some embodiments, the wide rings have a data capacity of up to 320-bits, and the narrow rings have a data capacity of up to 40-bits.

Once the nodes have been electrically coupled (605, 610, 615, 620) to the rings, data can be transported across the rings. Since the rings have different data capacities, one embodiment, among others, can be seen as including the step of determining (625) whether the data packet size exceeds the capacity of the narrow rings, and ascertaining the direction of data transport. For some embodiments, the direction of data transport is ascertained by determining (630, 635) whether the data direction is CW.

If the packet size exceeds the capacity of the narrow rings, and the data is traveling CW, then the data is placed (640) on the wide CW ring. If the packet size exceeds the capacity of the narrow rings, and the data is not traveling CW, then the data is placed (645) on the wide CCW ring. If the packet size does not exceed the capacity of the narrow rings, and the data is traveling CW, then the data is placed (650) on the narrow CW ring. If the packet size does not exceed the capacity of the narrow rings, and the data is not traveling CW, then the data is placed (655) on the narrow CCW ring.

As shown in the embodiment of FIG. 6, the electrical coupling (605, 610, 615, 620) of the nodes to the wide and narrow rings provides for a more efficient bi-directional communications using a ring architecture.

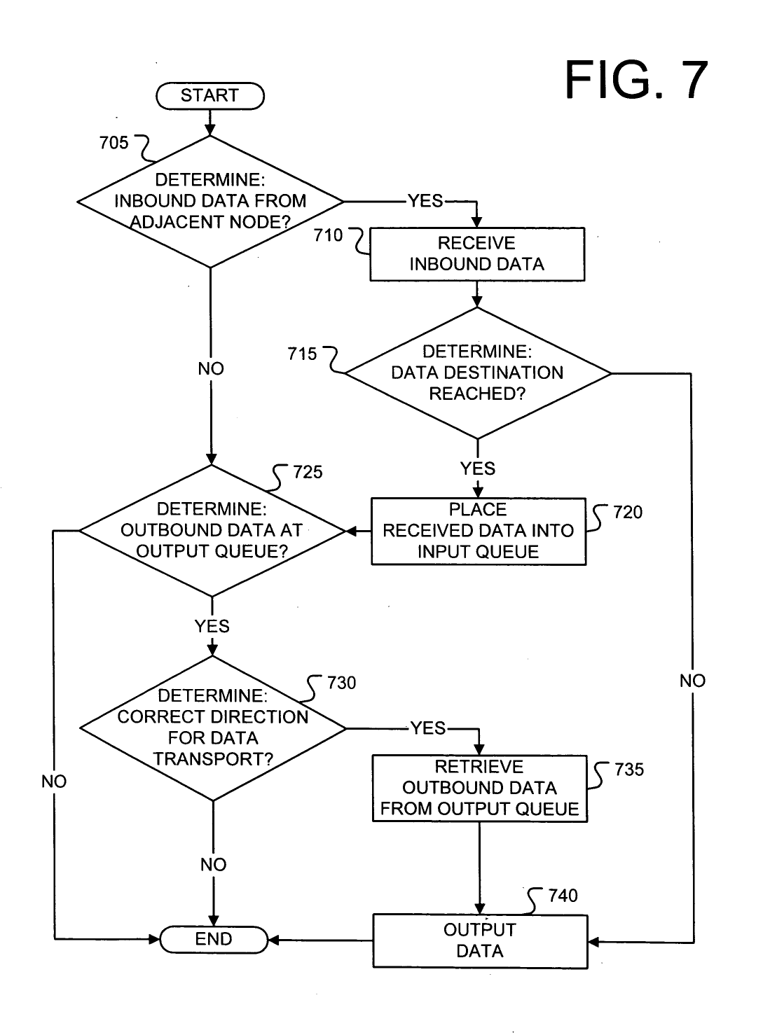

FIG. 7 is a flowchart showing an embodiment of a process that is carried out at one specific input or output of a node 110 in a ring architecture. In other words, FIG. 7 shows a process that is carried out at either a node in the clockwise direction or a node in the counterclockwise direction. As an exemplary embodiment, FIG. 7 shows a process for a wide ring. However, it should be appreciated that a similar process can be implemented for a narrow ring. Additionally, it should be appreciated that the flowchart of FIG. 7 can be readily modified to accommodate a process for systems that employ both wide and narrow rings.

As shown in FIG. 7, some embodiments of the process begin when the specified node 110 determines (705) whether or not there is inbound data on a wide ring from an adjacent node. If there is no inbound data from an adjacent node, the process further determines (725) whether or not there is any outbound data from the node 110 for the wide ring. If there is no outbound data, then the process terminates.

If there is no inbound data from an adjacent node, but there is outbound data to be transmitted from the node 110, then the process determines (730) whether the node 110 is associated with a ring that propagates data in the correct direction (e.g., clockwise or counterclockwise). If the process determines (730) that the node propagates data in the correct direction, then the process retrieves (735) the outbound data from the output queue, and outputs (740) the data to the wide ring that travels in the appropriate direction (e.g., either clockwise or counterclockwise). Alternatively, if the process determines (730) that the node does not propagate data in the correct direction, then the process ends.

If the process determines (705) that there is inbound data on a wide ring, then the process receives (710) the inbound data, and further determines (715) whether or not the inbound data has reached its destination. The destination is determined by destination information that is included in a data-type field of the data packet. If the node 110 is the proper destination for the received data packet, then that data is placed into the input queue of the node 10, and the process continues by further determining (725) whether or not there is any outbound data from the node 110, as described above.

If the node is not the proper destination for the data packet, then the process outputs (740) the data to the wide ring. Thereafter, the process terminates until the next polling cycle, which, for some embodiments, is the next clock cycle.

As noted above, since each node propagates data in both the clockwise and counterclockwise directions, and also on wide rings as well as narrow rings, it should be appreciated that the process of FIG. 7 exists for any permutation of clockwise rings, counterclockwise rings, wide rings, and narrow rings. As shown here, the process of FIG. 7 avoids deadlock conditions that can occur with other methods.

The ring architecture, as described herein, provides a scalable approach in which units (or nodes) can be easily added or removed. Additionally, by systematically varying the data capacity of the wide and narrow buses, the performance characteristics can be tuned to varying needs. In addition to scaling the number of nodes, it should be appreciated that the number of rings can also be scaled to accommodate varying needs. For example, rather than having two clockwise rings and two counterclockwise rings, additional rings may be added in either direction to provide further flexibility in data transport. Additionally, it should be appreciated that, if each node is fully synchronous, then the data can be cascaded seamlessly from node to node. Finally, the ring architecture, as provide above, is easy to implement with relatively little silicon area.

For illustrative purposes, the data packets, in C++, can be defined as two different classes, such as CTRL_ONLY_PACKET for the small packets and CTRL_DATA_PACKET for the large packets. In some embodiments, the classes can be defined using four (4) bits of information. Given these designations, the small and large packets can be defined as follows:

class CTRL_ONLY_PACKET {
public:

unsigned dst_peer : EB_BITS;
unsigned src_peer : EB_BITS;
PKT_TYPE pkt_type : RT_BITS;
U64 eb_ready : MAX_EBS;
union {

PP_DATA_REQUESTpp_drq;
PP_EB_ENUMERATEpp_enu;
PP_CREATE_1_REFpp_crt;
PP_Z_MASK_PACK pp_zmp;
PP_SP_ACTIVATE pp_spa;
}pay_load;

};

and

class CTRL_DATA_PACKET {
public:

unsigned dst_peer : EB_BITS;
unsigned src_peer : EB_BITS;
PKT_TYPE pkt_type : TT_BITS;
union {

PP_DATA_TRANSMIT pp_dtr;
PP_CREATE_N_REFpp_crt;
PP_TRIANGLE_SETUP pp_tse;
PP_TILE_OF_PIXELS pp_tip;
PP_BLOB_OF_PIXELS pp_bop;
PP_Z_COMPARISONpp_zcmp;
}pay_load;

};

Here, “dst_peer” designates the destination of the data packet; “src_peer” designates the source of the data packet; “eb_ready” provides free/busy information throughout the system; “pkt_type” provides information on they type of packet; and “pay_load” provides the contents of the data packet. In a preferred embodiment, “dst_peer” is five (5) bits, “src_peer” is five (5) bits, and “pkt_type” is four (4) bits. In a graphics processing system, the “pkt_type” can indicate that the information is related to triangle setup, texture samples, results of Z and stencil buffer comparisons, data being read from a frame buffer, data being written to a frame buffer, vertex information, geometry information, color information, or a plethora of other information. Hence, the payload will be interpreted in accordance with the “pkt_type” information that is provided in the data packet.

As an example, a data packet containing a Z comparison request for processing can contain a “PP_Z_COMPARISON” inside the packet. The “PP_Z_COMPARISON” can appear as:

class PP_Z_COMPARISON {
public:

int dt [WORD_SZ]
int contxt : CX_BITS;
int coor : Z_COOR;
int dst_pb : PB_BITS;
int V : 1;
int mask : MAX_SIM;

};

Here, “dt [WORD_SZ]” provides Z comparison coordinate data; “CX_BITS” provides the current context; “Z_COOR” provides identification of a component within the Z comparison package; “PB_BITS” provides the Z data entity; “1” provides orthogonality control information; and “MAX_SIM” provides the valid data mask information.

The packet processor 250 and its corresponding functional units, such as the inbound-data-determination logic 305, the destination determination logic 310, the input logic 315, the outbound-data-determination logic 320, the packet-size-determination logic 325, the output logic 330, the wide-clockwise-inbound logic 410, the wide-counterclockwise-inbound logic 430, the narrow-clockwise-inbound logic 420, the narrow-counterclockwise-inbound logic 440, the wide-clockwise-outbound logic 510, the wide-counterclockwise-outbound logic 530, the narrow-clockwise-outbound logic 520, and the narrow-counterclockwise-outbound logic 540, may be implemented in hardware, software, firmware, or a combination thereof.

In the preferred embodiment(s), the packet processor 250 and its corresponding functional units, such as the inbound-data-determination logic 305, the destination determination logic 310, the input logic 315, the outbound-data-determination logic 320, the packet-size-determination logic 325, the output logic 330, the wide-clockwise-inbound logic 410, the wide-counterclockwise-inbound logic 430, the narrow-clockwise-inbound logic 420, the narrow-counterclockwise-inbound logic 440, the wide-clockwise-outbound logic 510, the wide-counterclockwise-outbound logic 530, the narrow-clockwise-outbound logic 520, and the narrow-counterclockwise-outbound logic 540, can be implemented in hardware with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In an alternative embodiment, the packet processor 250 and its corresponding functional units, such as the inbound-data-determination logic 305, the destination determination logic 310, the input logic 315, the outbound-data-determination logic 320, the packet-size-determination logic 325, the output logic 330, the wide-clockwise-inbound logic 410, the wide-counterclockwise-inbound logic 430, the narrow-clockwise-inbound logic 420, the narrow-counterclockwise-inbound logic 440, the wide-clockwise-outbound logic 510, the wide-counterclockwise-outbound logic 530, the narrow-clockwise-outbound logic 520, and the narrow-counterclockwise-outbound logic 540, are implemented in software or firmware that is stored in a memory and that is executed by a suitable instruction execution system.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The functions associated with the packet processor 250 can be implemented in a packet processing program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations to the invention as described may be made. For example, while the embodiment of FIG. 1 shows eight (8) nodes 110 on the rings 120, 130, 140, 150, it should be readily appreciated that the number of nodes can easily be scaled to accommodate greater or fewer numbers of rings. Likewise, while some embodiments illustrate the operation of a single node for a single ring in a single direction, one having skill in the art will appreciate that the disclosed embodiments can readily be extended to protocols that can accommodate multiple nodes on multiple rings that travel in multiple directions. Thus, various permutations and combinations of those elements shown in FIGS. 1 through 7 will be apparent to those having skill in the art.

Also, one having skill in the art will appreciate that the clockwise and counterclockwise directions are arbitrary. Thus, while those directions are explicitly recited herein, it should be appreciated that they can readily be switched without adverse effect to the scope of the disclosure. In other words, the clockwise direction and the counterclockwise direction are used to illustrate relative directions, insofar as the clockwise direction transports data in one direction, while the counterclockwise direction transports data in another direction.

While the term “data” is used herein, in a broad sense, to denote any information that is transmitted or stored digitally, it should also be appreciated that, for specific embodiments, the data on the narrow ring can be “control” information while the data on the wide ring can include additional information that supplements the “control” information. For other embodiments, it should be appreciated that the wide ring and the narrow ring merely transport data in different packet sizes.

All such changes, modifications, and alterations should therefore be seen as within the scope of the disclosure.

1. In a ring architecture for transporting data, the ring architecture having nodes, the data comprising a payload, the data further comprising information indicative of a destination for the data, a node comprising:
a first wide input configured to receive data from a first wide ring;
a first narrow input configured to receive data from the first narrow ring;
a second wide input configured to receive data from a second wide ring;
a second narrow input configured to receive data from the second narrow ring;
a first wide output configured to place data onto the first wide ring;
a first narrow output configured to place data onto the first narrow ring;
a second wide output configured to place data onto the second wide ring;
a second narrow output configured to place data onto the second narrow ring; and
a packet processor configured to determine whether the node is a destination for received data, the packet processor being further configured to determine whether the data is being transported in a clockwise direction, the packet processor being further configured to determine whether the packet is transported on a wide ring.

2. A data transporting system, comprising:
a wide ring having a first data capacity;
a narrow ring having a second data capacity, the second data capacity being less than the first data capacity;
a transmitting node; and
a receiving node configured to receive data from the transmitting node over the wide ring, the receiving node further being configured to receive data from the transmitting node over the narrow ring.

3. The system of claim 2, wherein the receiving node comprises a packet processor, the packet processor comprising inbound-data-determination logic, the inbound-data-determination logic being configured to determine whether there is inbound data from the transmitting node.

4. The system of claim 3, wherein the packet processor further comprises:
destination-determination logic configured to determine, in response to determining that there is inbound data from the transmitting node, whether the receiving node is the destination for the inbound data; and
input logic configured to place the inbound data in an input queue, the data being placed in the input queue in response to determining that the receiving node is the destination for the inbound data, the input queue being configured to provide the inbound data to a process within the receiving node.

5. The system of claim 4, wherein the packet processor further comprises:
outbound-data-determination logic configured to determine, in response to placing the inbound data in the input queue, whether there is outbound data from the receiving node; and
output logic configured to output the outbound data from the receiving node, the data being output in response to determining that there is outbound data from the receiving node.

6. The system of claim 3, wherein the packet processor further comprises:
destination-determination logic configured to determine, in response to determining that there is inbound data from the transmitting node, whether the receiving node is the destination for the inbound data; and
output logic configured to output the inbound data from the receiving node, the data being output in response to determining that the receiving node is not the destination for the inbound data.

7. The system of claim 3, wherein the packet processor further comprises:
outbound-data-determination logic configured to determine, in response to determining that there is no inbound data from the transmitting node, whether there is outbound data from the receiving node; and
output logic configured to output the outbound data from the receiving node, the data being output in response to determining that there is outbound data from the receiving node.

8. The system of claim 7, wherein the packet processor further comprises packet-size-determination logic configured to determine whether a packet size of the outbound data is greater than the second data capacity.

9. The system of claim 8, wherein the output logic is further configured to place the outbound data on the narrow ring in response to determining that the packet size is not greater than the second data capacity.

10. The system of claim 8, wherein the output logic is further configured to place the outbound data on the wide ring in response to determining that the packet size is greater than the second data capacity.

11. The system of claim 2, wherein:
the wide ring is a clockwise wide ring, the clockwise wide ring being configured to transport data in a clockwise direction;
the narrow ring is a clockwise narrow ring, the clockwise narrow ring being configured to transport data in the clockwise direction; and
the transmitting node is a first transmitting node, the first transmitting node being located in the counterclockwise direction from the receiving node.

12. The system of claim 11, further comprising:
a counterclockwise wide ring configured to transport data in a counterclockwise direction, the counterclockwise wide ring having the first data capacity;
a counterclockwise narrow ring configured to transport data in a counterclockwise direction, the counterclockwise narrow ring having the second data capacity; and
a second transmitting node located in the clockwise direction from the receiving node.

13. The system of claim 12, wherein the receiving node comprises a packet processor, the packet processor comprising:
wide-clockwise-inbound logic configured to determine whether there is inbound data over the clockwise wide ring;
wide-counterclockwise-inbound logic configured to determine whether there is inbound data over the counterclockwise wide ring;
narrow-clockwise-inbound logic configured to determine whether there is inbound data over the clockwise narrow ring; and
narrow-counterclockwise-inbound logic configured to determine whether there is inbound data over the counterclockwise narrow ring.

14. The system of claim 13, wherein the packet processor further comprises:
destination-determination logic configured to determine, in response to determining that there is inbound data, whether the receiving node is the destination for the inbound data; and
input logic configured to place the inbound data in an input queue, the data being placed in the input queue in response to determining that the receiving node is the destination for the inbound data, the input queue being configured to provide the inbound data to a process within the receiving node.

15. The system of claim 13, wherein the packet processor further comprises:
destination-determination logic configured to determine, in response to determining that there is inbound data over the clockwise wide ring, whether the receiving node is the destination for the inbound data; and
wide-clockwise-outbound logic configured to output the inbound data onto the clockwise wide ring in response to determining that the receiving node is not the destination for the inbound data.

16. The system of claim 13, wherein the packet processor further comprises:
destination-determination logic configured to determine, in response to determining that there is inbound data over the clockwise narrow ring, whether the receiving node is the destination for the inbound data; and
narrow-clockwise-outbound logic configured to output the inbound data onto the clockwise narrow ring in response to determining that the receiving node is not the destination for the inbound data.

17. The system of claim 13, wherein the packet processor further comprises:
destination-determination logic configured to determine, in response to determining that there is inbound data over the counterclockwise wide ring, whether the receiving node is the destination for the inbound data; and
wide-counterclockwise-outbound logic configured to output the inbound data onto the counterclockwise wide ring in response to determining that the receiving node is not the destination for the inbound data.

18. The system of claim 13, wherein the packet processor further comprises:
destination-determination logic configured to determine, in response to determining that there is inbound data over the counterclockwise narrow ring, whether the receiving node is the destination for the inbound data; and
narrow-counterclockwise-outbound logic configured to output the inbound data onto the counterclockwise narrow ring in response to determining that the receiving node is not the destination for the inbound data.

19. The system of claim 13, wherein the packet processor further comprises:
wide-clockwise-outbound logic configured to determine, in response to determining that there is no inbound data, whether there is outbound data for placement on the clockwise wide ring; and
output logic configured to output the outbound data onto the clockwise wide ring, the data being output in response to determining that the there is outbound data for placement on the clockwise wide ring.

20. The system of claim 13, wherein the packet processor further comprises:
wide-counterclockwise-outbound logic configured to determine, in response to determining that there is no inbound data, whether there is outbound data for placement on the counterclockwise wide ring; and
output logic configured to output the outbound data onto the counterclockwise wide ring, the data being output in response to determining that the there is outbound data for placement on the counterclockwise wide ring.

21. The system of claim 13, wherein the packet processor further comprises:
narrow-clockwise-outbound logic configured to determine, in response to determining that there is no inbound data, whether there is outbound data for placement on the clockwise narrow ring; and
output logic configured to output the outbound data onto the clockwise narrow ring, the data being output in response to determining that the there is outbound data for placement on the clockwise narrow ring.

22. The system of claim 13, wherein the packet processor further comprises:
narrow-counterclockwise-outbound logic configured to determine, in response to determining that there is no inbound data, whether there is outbound data for placement on the counterclockwise narrow ring; and
output logic configured to output the outbound data onto the counterclockwise narrow ring, the data being output in response to determining that the there is outbound data for placement on the counterclockwise narrow ring.

23. A data transporting method, comprising the steps of:
electrically coupling a first node and a second node over a first wide ring, the first wide ring having a first data capacity, the first wide ring being configured to transport data in a first direction; and
electrically coupling the first node and the second node over a first narrow ring, the first narrow ring having a second data capacity, the second data capacity being less than the first data capacity, the first narrow ring being configured to transport data in the first direction.

24. The method of claim 23, further comprising the steps of:
electrically coupling the first node and the second node over a second wide ring, the second wide ring having the first data capacity, the second wide ring being configured to transport data in a second direction; and
electrically coupling the first node and the second node over a second narrow ring, the second narrow ring having the second data capacity, the second narrow ring being configured to transport data in the second direction.

25. In a system having a ring architecture with multiple nodes, a method comprising the steps of:
determining whether there is inbound data from an adjacent node;
receiving the inbound data from the adjacent node in response to determining that there is inbound data from the adjacent node; and
determining whether the received data has reached its destination.

26. The method of claim 25, further comprising the step of:
outputting the received data in response to determining that the received data has not reached its destination.

27. The method of claim 26, further comprising the steps of:
determining whether there is outbound data; and
outputting the outbound data in response to determining that there is outbound data.

28. The method of claim 27, wherein the step of outputting the outbound data comprises the steps of:
ascertaining a direction of travel associated with the outbound data; and
placing the outbound data on a ring that transports data in the ascertained direction.

29. The method of claim 25, further comprising the step of:
placing the received data into an input queue in response to determining that the received data has reached its destination.

30. The method of claim 29, further comprising the steps of:
determining whether there is outbound data; and
outputting the outbound data in response to determining that there is outbound data.

31. The method of claim 30, wherein the step of outputting the outbound data comprises the steps of:
ascertaining a direction of travel associated with the outbound data; and
placing the outbound data on a ring that transports data in the ascertained direction.

32. A computer-readable medium comprising:
computer-readable code adapted to instruct a programmable device to determine whether there is inbound data from an adjacent node;
computer-readable code adapted to instruct a programmable device to receive the inbound data from the adjacent node in response to determining that there is inbound data from the adjacent node; and
computer-readable code adapted to instruct a programmable device to determine whether the received data has reached its destination.

33. A data transporting system, comprising:
a first means for transporting data in a first direction; and
a second means for transporting data in the first direction, the first means having a greater data capacity than the second means.

34. The system of claim 33, further comprising:
a third means for transporting data in a second direction; and
a fourth means for transporting data in the second direction, the third means having a greater data capacity than the fourth means.

35. In a ring architecture having multiple nodes, a system comprising:
means for determining whether there is inbound data from an adjacent node;
means for receiving the inbound data from the adjacent node in response to determining that there is inbound data from the adjacent node; and
means for determining whether the received data has reached its destination.

36. The system of claim 35, further comprising:
means for outputting the received data in response to determining that the received data has not reached its destination.

37. The system of claim 36, further comprising:
means for determining whether there is outbound data; and
means for outputting the outbound data in response to determining that there is outbound data.

38. The system of claim 37, further comprising:
means for ascertaining a direction of travel associated with the outbound data; and
means for placing the outbound data on a ring that transports data in the ascertained direction.

39. The system of claim 35, further comprising:
means for placing the received data into an input queue in response to determining that the received data has reached its destination.

40. The system of claim 39, further comprising:
means for determining whether there is outbound data; and
means for outputting the outbound data in response to determining that there is outbound data.

41. The system of claim 40, further comprising:
means for ascertaining a direction of travel associated with the outbound data; and
means for placing the outbound data on a ring that transports data in the ascertained direction.
